(19) United States
(12) Patent Application Publication
(10) Pub. No.: US 2026/0290262 A1
(43) Pub. Date: Sep. 24, 2026

(54) METHOD OF DRIVING DISPLAY DEVICE, DISPLAY MODULE AND DISPLAY DEVICE

(71) Applicants: BEIJING BOE DISPLAY TECHNOLOGY CO., LTD., Beijing (CN); BOE TECHNOLOGY GROUP CO., LTD., Beijing (CN)

(72) Inventors: Zijiao Xue, Beijing (CN); Zhiqiang Wang, Beijing (CN); Jiaqi Li, Beijing (CN); Qiuli Wang, Beijing (CN); Wenhong Tian, Beijing (CN); Hao Zhang, Beijing (CN)

(73) Assignees: BEIJING BOE DISPLAY TECHNOLOGY CO., LTD., Beijing (CN); BOE TECHNOLOGY GROUP CO., LTD., Beijing (CN)

(21) Appl. No.: 18/881,085

(22) PCT Filed: Jul. 19, 2023
(86) PCT No.: PCT/CN2023/108123

§ 371 Date: Jan. 3, 2025

(30) Foreign Application Priority Data
Jul. 22, 2022 (CN) 202210870931.1

(51) Int. Cl. G09G 3/34; G02F 1/1335; G02F 1/13357

(52) U.S. Cl. CPC G09G 3/3413; G02F 1/133603; G02F 1/133612; G09G 2310/08; G09G 2320/0252; G09G 2330/021

(57) ABSTRACT

The present disclosure provides a method of driving a display device, a display module and a display device. The display device includes a backlight assembly, the backlight assembly includes a plurality of mutually independent backlight partitions, each backlight partition includes a plurality of light-emitting elements in different light-emission colors, and the method of driving the display device includes: receiving an image display instruction; and controlling the light-emitting elements in the backlight partitions to emit light sequentially according to the image display instruction.

### CROSS-REFERENCE TO RELATED APPLICATIONS

The present disclosure claims priority to Chinese patent application 202210870931.1 filed in China on Jul. 22, 2022, which is incorporated by reference herein in its entirety.

### TECHNICAL FIELD

Embodiments of the present disclosure relate to the field of display technologies, in particular to a method of driving a display device, a display module and a display device.

### BACKGROUND

A liquid crystal display device (LCD) for field sequential display provides color through a backlight, and since there is no need to provide a color filter, it has a higher transmittance as compared with a conventional LCD provided with a color filter, and has such advantages as low power consumption.

### SUMMARY

Embodiments of the present disclosure provide a method of driving a display device, a display module and a display device.

In a first aspect, the embodiments of the present disclosure provide a method of driving a display device, the display device includes a backlight assembly, the backlight assembly includes a plurality of mutually independent backlight partitions, each backlight partition includes a plurality of light-emitting elements in different light-emission colors; the method includes: receiving an image display instruction; and controlling the light-emitting elements in the backlight partitions to emit light sequentially according to the image display instruction.

In some embodiments, the controlling the light-emitting elements in the backlight partitions to emit light sequentially according to the image display instruction, includes: controlling the light-emitting elements in different backlight partitions to emit light during non-overlapping light-emission time periods; and controlling the light-emitting elements in different light-emission colors in a same backlight partition to emit light during non-overlapping light-emission time periods.

In some embodiments, each image frame of the display device includes a plurality of sub-pixel frames corresponding to light-emitting elements in different light-emission colors, each sub-pixel frame includes a scanning time period and a light-emission time period, and duration of the scanning time period is greater than or equal to duration of the light-emission time period. The controlling the light-emitting elements in the backlight partitions to emit light sequentially according to the image display instruction, includes: in an Nth sub-pixel frame, controlling a starting time of the light-emission time period of the backlight assembly to be between the scanning time period of the Nth sub-pixel frame and a starting time of the scanning time period of an (N+1)th sub-pixel frame, N being a positive integer.

In some embodiments, the light-emitting elements include first light-emitting elements, second light-emitting elements and third light-emitting elements, the light-emission colors of the first light-emitting elements, the second light-emitting elements and the third light-emitting elements are different; and the controlling the light-emitting elements in the backlight partitions to emit light sequentially according to the image display instruction, includes: in a plurality of successive sub-pixel frames, controlling the first light-emitting elements, the second light-emitting elements and the third light-emitting elements to emit light sequentially and cyclically.

In some embodiments, the controlling the first light-emitting elements, the second light-emitting elements and the third light-emitting elements to emit light sequentially and cyclically, includes:
controlling the first light-emitting elements in the backlight partitions to emit light sequentially during a light-emission time period of a sub-pixel frame corresponding to the first light-emitting element; and/or
controlling the second light-emitting elements in the backlight partitions to emit light sequentially during a light-emission time period corresponding to the second light-emitting elements; and/or
controlling the third light-emitting elements in the backlight partitions to emit light sequentially during a light-emission time period corresponding to the third light-emitting elements.

In some embodiments, the controlling the light-emitting elements in the backlight partitions to emit light sequentially according to the image display instruction, includes: controlling a falling edge of a light-emission control signal of a backlight partition which is the first to emit light in the plurality of the backlight partitions at the Nth sub-pixel frame, to correspond to a rising edge of a synchronization signal of the (N+1)th sub-pixel frame.

In some embodiments, the controlling the light-emitting elements in the backlight partitions to emit light sequentially according to the image display instruction, includes: controlling a falling edge of a light-emission control signal of a backlight partition which is the last to emit light in the plurality of the backlight partitions at the Nth sub-pixel frame, to correspond to a rising edge of a light-emission control signal of a backlight partition which is the first to emit light in the plurality of the backlight partitions at an (N+2)th sub-pixel frame.

In some embodiments, the controlling the light-emitting elements in the backlight partitions to emit light sequentially according to the image display instruction, includes: inserting a blank sub-frame between some or all of two adjacent sub-pixel frames.

In some embodiments, the method further includes: writing pixel data by using overvoltage driving during the scanning time period of the sub-pixel frame.

In a second aspect, the embodiments of the present disclosure provide a display module including a backlight assembly and a liquid crystal panel, the backlight assembly includes a plurality of mutually independent backlight partitions, and each backlight partition includes a plurality of light-emitting elements in different light-emission colors, the light-emitting elements in different backlight partitions are driven independently, and the light-emitting elements with a same color in a same backlight partition are driven synchronously.

In some embodiments, the backlight assembly further includes a control switch corresponding to each backlight partition, a first terminal of each light-emitting element in the backlight partition is connected to a first electrode via a corresponding control switch; and a second terminal of each light-emitting element in the backlight partition is electrically connected to a second electrode, where second electrodes corresponding to different light-emitting elements are independent from each other.

In some embodiments, the backlight assembly is a direct-type backlight assembly.

In a third aspect, the embodiments of the present disclosure provide a display device including the above-mentioned display module.

In some embodiments, the display device is a near-eye display device.

### BRIEF DESCRIPTION OF THE DRAWINGS

In order to illustrate the technical solutions of the embodiments of the present disclosure in a clearer manner, the drawings required for the description of the embodiments of the present disclosure will be described hereinafter briefly. Apparently, the following drawings merely relate to some embodiments of the present disclosure, and based on these drawings, a person of ordinary skill in the art may obtain other drawings without any creative effort.

FIG. 1 is a schematic view showing a structure of a backlight assembly according to the embodiments of the present disclosure;

FIG. 2 is a control timing sequence diagram of a display module according to the embodiments of the present disclosure;

FIG. 3 is a flowchart of a method of driving a display device according to the embodiments of the present disclosure;

FIG. 4 is a timing sequence diagram of the method of driving the display device according to the embodiments of the present disclosure; and

FIG. 5 is another timing sequence diagram of the method of driving the display device according to the embodiments of the present disclosure.

### DETAILED DESCRIPTION

The technical solutions in the embodiments of the present disclosure will be described hereinafter clearly and completely with reference to the drawings of the embodiments of the present disclosure. Apparently, the following embodiments merely relate to a part of, rather than all of, the embodiments of the present disclosure, and based on these embodiments, a person of ordinary skill in the art may, without any creative effort, obtain other embodiments, which also fall within the scope of the present disclosure.

Terms such as “first” and “second” in the embodiments of the present disclosure are used to distinguish similar objects and are not necessarily used to describe a specific order or sequence. In addition, terms such as “including” and “having” and any variations thereof are intended to cover non-exclusive inclusion. For example, a process, method, system, product or device including a series of steps or units is not limited to the steps or units that are clearly listed and may include other steps or units that are not clearly listed or are inherent to the process, method, product, or device. Moreover, the term “and/or” used in the present disclosure indicates involving at least one of connected objects, for example, A and/or B and/or C means 7 situations, including: A alone, B alone, C alone, both A and B, both B and C, both A and C, and all of A, B and C.

Embodiments of the present disclosure provide a display module and a display device including the display module.

In one embodiment, the display module may specifically be a field sequential display module, which in one exemplary embodiment includes a backlight assembly and a liquid crystal panel.

It will be appreciated that in specific application scenarios, such as near-eye display devices, higher requirements are placed on the display effect. An illustrative description is given by using the near-eye display device. The near-eye display device is closer to eyes of a user, it is easier for the user to directly observe display details of the display device, so that the display effect requirements of the display device are more demanding.

In general, a pixel density of a liquid crystal display device is difficult to reach above 1500 PPI (Pixels Per Inch, the quantity of pixels per inch). Since a field sequential display device does not require a color film to be provided, a transmittance is higher, and it is able to achieve a higher pixel density, for example, it may reach above 2000 PPI. In addition, as the transmittance increases, the brightness loss is reduced, and accordingly, the energy consumption of a backlight may also be reduced; therefore, the field sequential display module has a wider application prospect.

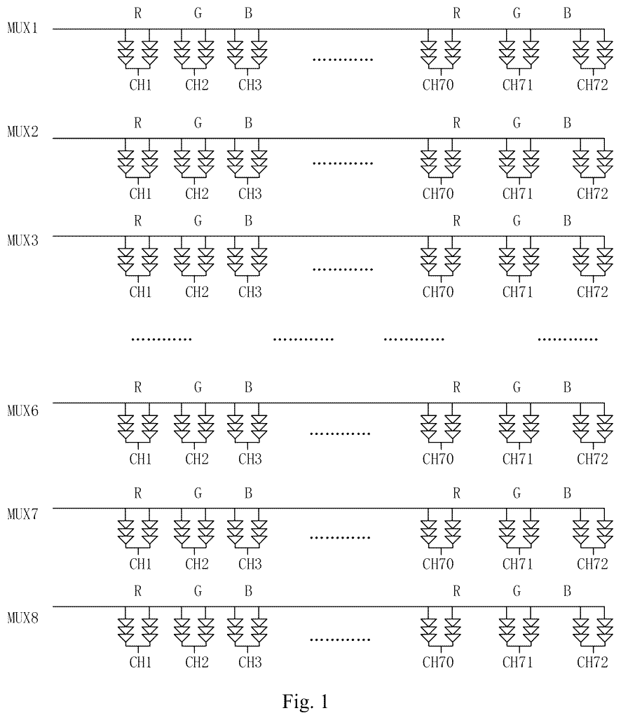

In some embodiments, the light-emitting elements comprise first light-emitting elements, second light-emitting elements and third light-emitting elements, and the light-emission colors of the first light-emitting elements, the second light-emitting elements and the third light-emitting elements are different. Illustratively, as shown in FIG. 1, the first light-emitting element, the second light-emitting element and the third light-emitting element may be red light-emitting elements R, green light-emitting elements G and blue light-emitting elements B respectively, so as to provide a backlight of three primary colors.

During the operation, the first light-emitting elements, the second light-emitting elements and the third light-emitting elements are controlled to emit light sequentially and cyclically in a plurality of successive sub-pixel frames.

In the embodiments of the present disclosure, the liquid crystal panel is a liquid crystal panel without a color filter. During the operation, in each of successive three frames, the light-emitting elements in one of the three primary colors red, green and blue emit light, and in the corresponding three frames, it may be understood that a red image, a green image and a blue image are respectively displayed. Furthermore, in combination with the control of the light transmission of the panel, it is equivalent to respectively displaying a red sub-pixel, a green sub-pixel and a blue sub-pixel of an image in every successive three frames, which are namely a red sub-pixel frame, a green sub-pixel frame and a blue sub-pixel frame respectively. In this way, it is able to realize full color display.

In one embodiment, the backlight assembly may be an edge-type backlight assembly. In other embodiments, the backlight assembly may also be a direct-type backlight assembly, which can be used to provide more response time for the liquid crystal, helping to improve display clarity.

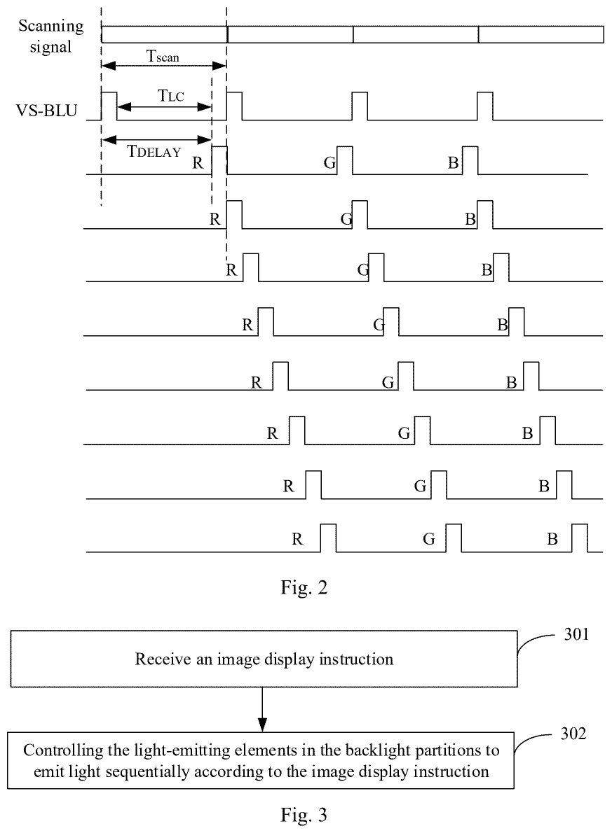

As shown in FIGS. 1 and 2, in one embodiment, the light-emitting elements in different backlight partitions are driven independently, and the light-emitting elements of the same color within the same backlight partition are driven synchronously. It can be understood that light-emission states of different backlight partitions are controlled independently of each other, and in each backlight partition, the light-emitting elements in the same color emit light at the same time or turn off at the same time, and in the same backlight partition, the light-emitting elements in different colors are controlled independently of each other.

As shown in FIG. 1, in some embodiments, the backlight assembly further includes a control switch corresponding to each backlight partition. In the embodiments of the present disclosure, a total of eight backlight partitions including backlight partition 1 to backlight partition 8 are exemplified, and MUX1 to MUX8 are control switches corresponding to backlight partition 1 to backlight partition 8 respectively.

A first terminal of each light-emitting element in the backlight partition is connected to the first electrode via a corresponding control switch, and a second terminal of each light-emitting element in the backlight partition is electrically connected to a second electrode, where the second electrodes corresponding to different light-emitting elements are independent from each other.

In an exemplary embodiment, each backlight partition may further be divided into a plurality of sub-partitions, each sub-partition includes one or more light-emitting elements in the same color, each light-emitting element may be a light emitting diode LED group, or an organic light emitting diode OLED element, etc.

It will be appreciated that the quantity of sub-partitions, the order of arrangement, the specific type of light-emitting element, etc. may be adjusted as desired, and are not further defined and described in the embodiments of the present disclosure.

In the embodiments of the present disclosure, the light-emission control for each backlight partition is realized via a switch corresponding to each backlight partition.

Exemplarily, a total of eight backlight partitions are included, and a first terminal of each light-emitting element in each backlight partition is connected to a corresponding control switch (MUX1 to MUX8), and is connected to the first electrode through the control switch, thereby controlling a power supply state of the light-emitting element in the corresponding backlight partition through the control switch. A second terminal of each light-emitting element is connected to the second electrode, and second electrodes are independent from each other. During the implementation, it is able to control the ON time of each sub-partition via the second electrode, thereby achieving brightness control of each sub-partition.

Illustratively, one of the first electrode and the second electrode may be a positive electrode of a power source and the other may be a negative electrode of the power source.

Illustratively, in one embodiment, each backlight partition includes 72 sub-partitions including red sub-partitions, green sub-partitions and blue sub-partitions arranged sequentially and cyclically, each sub-partition including a plurality of LED groups. Positive electrodes of each LED group are connected to the positive electrode of the power source through a control switch corresponding to each backlight partition, and negative electrodes of each LED group are connected to the negative electrode of the power source. In the embodiments of the present disclosure, CH1 to CH72 are respectively exemplified to represent connection terminals of the negative electrodes of each LED group.

The embodiments of the present disclosure provide a display device including the above-mentioned display module.

In some embodiments, the display device is a near-eye display device, illustratively a wearable near-eye display device such as an AR (Augmented Reality) or VR (Virtual Reality) device.

When the display device is a near-eye display device, it usually requires to arrange a lens or group of lenses in front of the display module to magnify the image, thereby to facilitate viewing by the user.

The embodiments of the present disclosure provide a method of driving a display device, the display device includes a backlight assembly, the backlight assembly includes a plurality of mutually independent backlight partitions, and each backlight partition includes a plurality of light-emitting elements in different light-emission colors.

As shown in FIG. 3, in one embodiment, the method of driving the display device includes:
Step 301: receiving an image display instruction; and
Step 302: controlling the light-emitting elements in the backlight partitions to emit light sequentially according to the image display instruction.

In the technical solution of the embodiments, the image display instruction may be a control instruction for displaying an image corresponding to a signal source, for example, a control instruction for displaying an image corresponding to a signal provided by a signal source such as an upper computer or a network signal, or a control instruction for displaying a specific image such as a standby image or a power-on image. Generally, a user can control the display device to send the image display instruction by means of a switch key, a signal control key, a sound control, a touch control, etc. so as to control the display device to display an image.

When displaying an image, the light-emitting elements in the backlight partitions emit light sequentially.

In some embodiments, Step 302 specifically includes:
controlling the light-emitting elements in different backlight partitions to emit light during non-overlapping light-emission time periods; and
controlling the light-emitting elements in different light-emission colors in a same backlight partition to emit light during non-overlapping light-emission time periods.

That is, in this embodiment, the light-emission time periods of the light-emitting elements in different backlight partitions do not overlap each other, and the light-emission time periods of the light-emitting elements in different light-emission colors within the same backlight partition do not overlap each other.

It may be understood that, at the same time, at most the light-emitting elements of one color in one backlight partition are in the light-emission state.

In some embodiments, Step 302 specifically includes: controlling the first light-emitting elements in the backlight partitions to emit light sequentially during a light-emission time period of a sub-pixel frame corresponding to the first light-emitting elements; and/or controlling the second light-emitting elements in the backlight partitions to emit light sequentially during a light-emission time period corresponding to the second light-emitting element; and/or controlling the third light-emitting elements in the backlight partitions to emit light sequentially during a light-emission time period corresponding to the third light-emitting elements.

A total of eight backlight partitions including the backlight partition 1 to the backlight partition 8 are exemplified. During the implementation, at a first stage, red light-emitting elements R in the backlight partition 1 to the backlight partition 8 emit light sequentially, at a second stage, green light-emitting elements G in the backlight partition 1 to the backlight partition 8 emit light sequentially, and at a third stage, blue light-emitting elements B in the backlight partition 1 to the backlight partition 8 emit light sequentially. Next, the red light-emitting elements R in the backlight partition 1 to the backlight partition 8 are controlled to emit light sequentially again, and so on.

In another embodiment, the red light-emitting elements R, the green light-emitting elements G and the blue light-emitting elements B in the backlight partition 1 are sequentially controlled to emit light. Next, the red light-emitting elements R, the green light-emitting elements G and the blue light-emitting elements B in the backlight partition 2 are sequentially controlled to emit light. In this way, until the light-emitting elements in all the backlight partitions have emitted light, the light-emitting elements in the backlight partitions 1 are controlled to emit light again, and so on.

It will be appreciated that in a specific application scenario, higher requirements are placed on the display effect. An illustrative description is given by using the near-eye display device. The near-eye display device is closer to the user's eye and a lens is added between the display panel and the user's eye to magnify the image, so that image smears caused by the liquid crystal response are more easily observed by the user.

Furthermore, in order to ensure the display effect of the near-eye display device, the refresh rate thereof is also relatively high. In a case where the image refresh rate of the display device reaches 90 Hz, for a field sequential display device, each image frame is actually obtained by combining three images, namely, a red sub-pixel image, a green sub-pixel image and a blue sub-pixel image; so the actual refresh rate of the display device is three times the image refresh rate, namely, 270 Hz. Thus, the time of each frame is about 3.7 milliseconds, and there is a high requirement for the liquid crystal response time. In general, the conventional mass-produced liquid crystal gray scale response time (GTG) is about 4.5 ms or so, which results in that the liquid crystal response time and frame rate cannot be matched.

The inventors of the present disclosure believe that there are at least two manners to address the issue that the response time of the liquid crystal and the frame rate cannot be matched, namely, to develop a liquid crystal material with a faster response speed and to provide more response time for the liquid crystal.

In the technical solution of the embodiments of the present disclosure, the issue that the response time of the liquid crystal and the frame rate cannot be matched is addressed by providing more response time for the liquid crystal.

Specifically, in the embodiments of the present disclosure, the backlight module is divided into a plurality of backlight partitions, and the light-emitting elements in the backlight partitions are controlled to be turned on sequentially, so as to provide sufficient response time for the liquid crystal.

In some embodiments, each image frame of the display device includes a plurality of sub-pixel frames corresponding to light-emitting elements in different light-emission colors, and by way of example, including three sub-pixel frames corresponding to red sub-pixels, blue sub-pixels and green sub-pixels, respectively.

Each sub-pixel frame includes a scanning time period and a light-emission time period, during the scanning time period, pixel data is written, the liquid crystal panel drives the liquid crystal to deflect according to the written pixel data, and during the light-emission time period, the backlight assembly emits light, so as to display sub-pixels in a corresponding color.

The duration of the scanning time period is greater than or equal to the duration of the light-emission time period. In one embodiment, in order to increase the display brightness, it is preferable to control the duration of the scanning time period to be equal to the duration of the light-emission time period.

As shown in FIG. 2, in some of the embodiments, the synchronization control of the scanning time period and the light-emission time period is realized by using a synchronization signal VS-BLU, where each rising edge of the synchronization signal VS-BLU corresponds to starting time of each scanning time period, i.e., each rising edge of the synchronization signal VS-BLU is at the same time as the starting time of each scanning time period.

With reference to FIG. 2, MUX1 to MUX8 in FIG. 2 respectively represent light-emission control signals of eight backlight partitions, where R, G and B respectively represent light-emission control signals for the red light-emitting elements, the green light-emitting elements and the blue light-emitting elements. When the light-emission control signal is at a high level, the corresponding light-emitting element is in a light-emitting state; and when the light-emission control signal is at a low level, the corresponding light-emitting element is in an off state.

In some of the embodiments, the light-emission time period is controlled by the light-emission control signal, it may be appreciated that a rising edge of the light-emission control signal corresponds to starting time of the light-emission time period and a falling edge of the light-emission control signal corresponds to end time of the light-emission time period.

In some of the embodiments, Step 302 specifically includes: in an Nth sub-pixel frame, controlling starting time of the light-emission time period of the backlight assembly to be between the scanning time period of the Nth sub-pixel frame and starting time of the scanning time period of an (N+1)th sub-pixel frame, N being a positive integer.

In other words, the rising edge of the light-emission control signal of the Nth sub-pixel frame is located between the rising edge of the synchronization signal VS-BLU of the Nth sub-pixel frame and the rising edge of the synchronization signal VS-BLU of the (N+1)th sub-pixel frame.

As shown in FIG. 2, it may be appreciated that when the scanning time period of a next sub-pixel frame has not been entered, the backlight is energized, so that the image tearing phenomenon does not occur between two adjacent sub-pixel frames.

In some embodiments, a falling edge of a light-emission control signal of a backlight partition which is the first to emit light in the plurality of the backlight partitions at the Nth sub-pixel frame, corresponds to a rising edge of a synchronization signal VS-BLU of the (N+1)th sub-pixel frame.

In some embodiments, a falling edge of a light-emission control signal of a backlight partition which is the last to emit light in the plurality of the backlight partitions at the Nth sub-pixel frame, corresponds to a rising edge of a light-emission control signal of a backlight partition which is the first to emit light in the plurality of the backlight partitions at an (N+2)th sub-pixel frame.

In the embodiments of the present disclosure, an illustrative description is given by taking that the backlight partition 1 to the backlight partition 8 emit light sequentially as an example, the backlight partition 1 is a light-emitting partition which is the first to emit light in the plurality of backlight partitions, the backlight partition 8 is a light-emitting partition which is the last to emit light in the plurality of backlight partitions, the falling edge of the light-emission control signal of the backlight partition 1 at the Nth sub-pixel frame corresponds to the rising edge of the synchronization signal VS-BLU of the (N+1)th sub-pixel frame, the falling edge of the light-emission control signal of the backlight partition 8 at the Nth sub-pixel frame corresponds to the rising edge of the light-emission control signal of the backlight partition 1 at the (N+2)th sub-pixel frame.

$${T}_{DELAY} = {T}_{scan} * 7 / 8 = {T}_{scan} * 1 / 8 + {T}_{LC} ; \qquad ( 1 )$$

$${T}_{LC} = {T}_{scan} * 6 / 8 \approx 2.77 ms ; \qquad ( 2 )$$

With reference to the above-mentioned equations 1 and 2, in the technical solution of the embodiments of the present disclosure, an illustrative description is given by taking that the duration of the scanning time period is equal to the light-emission time period as an example, in the case of eight backlight partitions, the light-emitting duration of each backlight partition is one eighth of the total duration of the light-emission time period, and the duration TDELAY between the rising edge of the synchronization signal VS-BLU (namely, the starting time of the scanning time period) and the rising edge of the light-emission control signal of the backlight partition which is the first to emit light (e.g., the backlight partition 1) is seven eighths of the scanning time period T_{scan}. The duration between the falling edge of the synchronization signal VS-BLU and the rising edge of the light-emission control signal may be considered as the provided liquid crystal response time TLC, and the duration between the rising edge of the synchronization signal VS-BLU and the falling edge of the synchronization signal VS-BLU is one eighth of the duration of the scanning time period, and then the provided liquid crystal response time TLC is six eighths of the scanning time period T_{scan}.

In the case where the image refresh rate is 90 Hz, the corresponding refresh rate of a sub-pixel frame is 270 Hz, the duration of the scanning time period of each sub-pixel frame is 1/270 second, which is approximately equal to 3.7 milliseconds, and the provided liquid crystal response duration is 3.7 milliseconds*6/8, which is approximately 2.77 milliseconds.

It should be appreciated that, during the implementation, the quantity of backlight partitions may be determined based on the refresh rate of the display device and the desired liquid crystal response duration, so as to meet the use requirements of the display device.

In some embodiments, Step 302 further includes: inserting a blank sub-frame between some or all of two adjacent sub-pixel frames.

In this embodiment, part or all of the image frames of the display device further include a blank sub-frame, and the blank sub-frame is arranged between two adjacent sub-pixel frames.

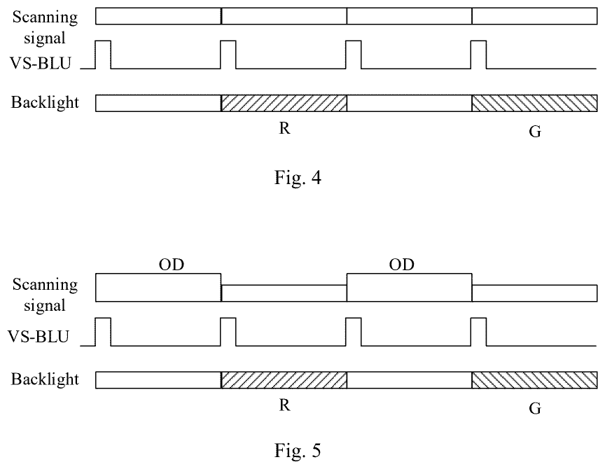

In some of the embodiments, as shown in FIG. 4, one blank sub-frame may be inserted into two adjacent sub-pixel frames.

In one exemplary embodiment, the blank sub-frame, the red sub-pixel frame, the blank sub-frame, the green sub-pixel frame, the blank sub-frame, and the blue sub-pixel frame are arranged sequentially and cyclically. The scanning time period and the light-emission time period for the sub-pixel frames and the blank sub-frames are arranged alternately.

As shown in FIG. 4, the scanning time period of the red sub-pixel frame and the light-emitting time period of the blank sub-frame correspond in time, where the backlight is in an off state during the light-emitting time period of the blank sub-frame, and this time period may also be understood as the provided liquid crystal response time. Next, during the scanning time period of the blank sub-frame, scanning operation is not actually performed, and during this time period, the red light-emitting elements R emit light, which is equivalent to activating red sub-pixels. Next, a scanning time period of the green sub-pixel frame is entered, and this time period also corresponds to a light-emission time period of one blank sub-frame. Next, during the scanning time period of the blank sub-frame, no scanning operation is actually performed, and during this time period, the green light-emitting elements G emit light, which is equivalent to activating green sub-pixels, and so on.

When the blank sub-frames and the sub-pixel frames are alternately arranged, it is able to provide the liquid crystal response time for each sub-pixel frame, so as to improve the display effect.

As shown in FIG. 5, in some embodiments, the method further includes: writing pixel data by using overvoltage driving during the scanning time period of the sub-pixel frame.

In this embodiment, it is also able to improve the liquid crystal response speed by means of overvoltage driving (Over Driving, OD) during the scanning time period of the sub-pixel frame, which contributes to improving the display effect.

With reference to FIG. 4 at the same time, in the technical solution of this embodiment, a driving manner of the display panel is similar to that of the embodiment shown in FIG. 4, namely, inserting one blank sub-frame into two adjacent sub-pixel frames, so as to use the blank sub-frame as the provided liquid crystal response time, thereby to provide a sufficient response time for the liquid crystal and improve the display effect. The difference with the embodiment shown in FIG. 4 is that, in this embodiment, the overvoltage driving is further performed during the scanning stage of the sub-pixel frame, so as to increase the voltage difference, thereby to improve the liquid crystal response speed. The overvoltage driving itself may refer to the related art and will not be described in detail herein.

The above embodiments are optional embodiments of the present disclosure, it should be appreciated that those ordinary skilled in the art may make various improvements and modifications without departing from the principle of the present disclosure, and theses improvement and modifications shall fall within the scope of the present disclosure.

1. A method of driving a display device, the display device comprising a backlight assembly, the backlight assembly comprising a plurality of mutually independent backlight partitions, each backlight partition comprising a plurality of light-emitting elements in different light-emission colors; the method comprising:
receiving an image display instruction; and
controlling the light-emitting elements in the backlight partitions to emit light sequentially according to the image display instruction.

2. The method according to claim 1, wherein the controlling the light-emitting elements in the backlight partitions to emit light sequentially according to the image display instruction, comprises:
controlling the light-emitting elements in different backlight partitions to emit light during non-overlapping light-emission time periods; and
controlling the light-emitting elements of different light-emission colors in a same backlight partition to emit light during non-overlapping light-emission time periods.

3. The method according to claim 2, wherein each image frame of the display device comprises a plurality of sub-pixel frames corresponding to the light-emitting elements in different light-emission colors, wherein each sub-pixel frame comprises a scanning time period and a light-emission time period, and duration of the scanning time period is greater than or equal to duration of the light-emission time period; and
the controlling the light-emitting elements in the backlight partitions to emit light sequentially according to the image display instruction, comprises:
in an Nth sub-pixel frame, controlling starting time of the light-emission time period of the backlight assembly to be between the scanning time period of the Nth sub-pixel frame and starting time of the scanning time period of an (N+1)th sub-pixel frame, N being a positive integer.

4. The method according to claim 3, wherein the light-emitting elements comprise first light-emitting elements, second light-emitting elements and third light-emitting elements, wherein the light-emission colors of the first light-emitting elements, the second light-emitting elements and the third light-emitting elements are different; and
the controlling the light-emitting elements in the backlight partitions to emit light sequentially according to the image display instruction, comprises:
in a plurality of successive sub-pixel frames, controlling the first light-emitting elements, the second light-emitting elements and the third light-emitting elements to emit light sequentially and cyclically.

5. The method according to claim 4, wherein the controlling the first light-emitting elements, the second light-emitting elements and the third light-emitting elements to emit light sequentially and cyclically, comprises:
controlling the first light-emitting elements in the backlight partitions to emit light sequentially during a light-emission time period of a sub-pixel frame corresponding to the first light-emitting elements; and/or
controlling the second light-emitting elements in the backlight partitions to emit light sequentially during a light-emission time period corresponding to the second light-emitting elements; and/or
controlling the third light-emitting elements in the backlight partitions to emit light sequentially during a light-emission time period corresponding to the third light-emitting elements.

6. The method according to claim 3, wherein the controlling the light-emitting elements in the backlight partitions to emit light sequentially according to the image display instruction, comprises:
controlling a falling edge of a light-emission control signal of a backlight partition which is the first to emit light in the plurality of the backlight partitions at the Nth sub-pixel frame, to correspond to a rising edge of a synchronization signal of the (N+1)th sub-pixel frame.

7. The method according to claim 3, wherein the controlling the light-emitting elements in the backlight partitions to emit light sequentially according to the image display instruction, comprises:
controlling a falling edge of a light-emission control signal of a backlight partition which is the last to emit light in the plurality of the backlight partitions at the Nth sub-pixel frame, to correspond to a rising edge of a light-emission control signal of a backlight partition which is the first to emit light in the plurality of the backlight partitions at an (N+2)th sub-pixel frame.

8. The method according to claim 3, wherein the controlling the light-emitting elements in the backlight partitions to emit light sequentially according to the image display instruction, comprises:
inserting a blank sub-frame between some or all of two adjacent sub-pixel frames.

9. The method according to claim 8, further comprising:
writing pixel data by using overvoltage driving during the scanning time period of the sub-pixel frame.

10. A display module comprising a backlight assembly and a liquid crystal panel, wherein the backlight assembly comprises a plurality of mutually independent backlight partitions, and each backlight partition comprises a plurality of light-emitting elements in different light-emission colors, wherein the light-emitting elements in different backlight partitions are driven independently, and the light-emitting elements with a same color in a same backlight partition are driven synchronously.

11. The display module according to claim 10, wherein the backlight assembly further comprises a control switch corresponding to each backlight partition, a first terminal of each light-emitting element in the backlight partition is connected to a first electrode via a corresponding control switch; and a second terminal of each light-emitting element in the backlight partition is electrically connected to a second electrode, wherein second electrodes corresponding to different light-emitting elements are independent from each other.

12. The display module according to claim 10, wherein the backlight assembly is a direct-type backlight assembly.

13. A display device comprising the display module according to claim 10.

14. The display device according to claim 13, wherein the display device is a near-eye display device.

15. The display module according to claim 10, wherein the backlight assembly further comprises a control switch corresponding to each backlight partition, a first terminal of each light-emitting element in the backlight partition is connected to a first electrode via a corresponding control switch; and a second terminal of each light-emitting element in the backlight partition is electrically connected to a second electrode, wherein second electrodes corresponding to different light-emitting elements are independent from each other;
wherein the backlight assembly is a direct-type backlight assembly.

16. The display device according to claim 13, wherein the backlight assembly further comprises a control switch corresponding to each backlight partition, a first terminal of each light-emitting element in the backlight partition is connected to a first electrode via a corresponding control switch; and a second terminal of each light-emitting element in the backlight partition is electrically connected to a second electrode, wherein second electrodes corresponding to different light-emitting elements are independent from each other.

17. The display device according to claim 13, wherein the backlight assembly is a direct-type backlight assembly.

18. The display device according to claim 13, wherein the backlight assembly further comprises a control switch corresponding to each backlight partition, a first terminal of each light-emitting element in the backlight partition is connected to a first electrode via a corresponding control switch; and a second terminal of each light-emitting element in the backlight partition is electrically connected to a second electrode, wherein second electrodes corresponding to different light-emitting elements are independent from each other;
wherein the backlight assembly is a direct-type backlight assembly.
